(19) United States
(12) Patent Application Publication
(10) Pub. No.: US 2012/0020011 A1
(43) Pub. Date: Jan. 26, 2012

(54) DATA CENTER AND SERVER MODULE OF THE SAME

(75) Inventor: YAO-TING CHANG, Tu-Cheng (TW)

(73) Assignee: HON HAI PRECISION INDUSTRY CO., LTD., Tu-Cheng (TW)

(21) Appl. No.: 12/871,851

(22) Filed: Aug. 30, 2010

(30) Foreign Application Priority Data
Jul. 22, 2010 (TW) 99124089

(51) Int. Cl. G06F 1/20; G06F 1/16; A47B 81/00

(52) U.S. Cl. 361/679.46; 211/26; 361/679.02

(57) ABSTRACT

A data center includes a rack mounted with two first slide rails, a server module arranged in the rack. Two second slide rails are mounted on the top and bottom sidewalls of the server module, to mate with the first slide rails, thereby slidably attaching the server module to the rack.

### BACKGROUND

1. Technical Field

The present disclosure relates to a data center and a server module of the data center.

2. Description of Related Art

A data center usually includes a number of server modules. Referring to FIG. 1, two slide rails 400 are attached to the left and right sidewalls of each server module 200, and the slide rails 400 are slidably mounted to slide rails 300 of a housing 100 of the data center. As a result, heat dissipation holes cannot be defined in the left and right sidewalls of the server module, thus, the heat dissipation holes defined in the front and back sidewalls of the server module is insufficient for heat dissipation.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a sketch view of a data center of a related art.

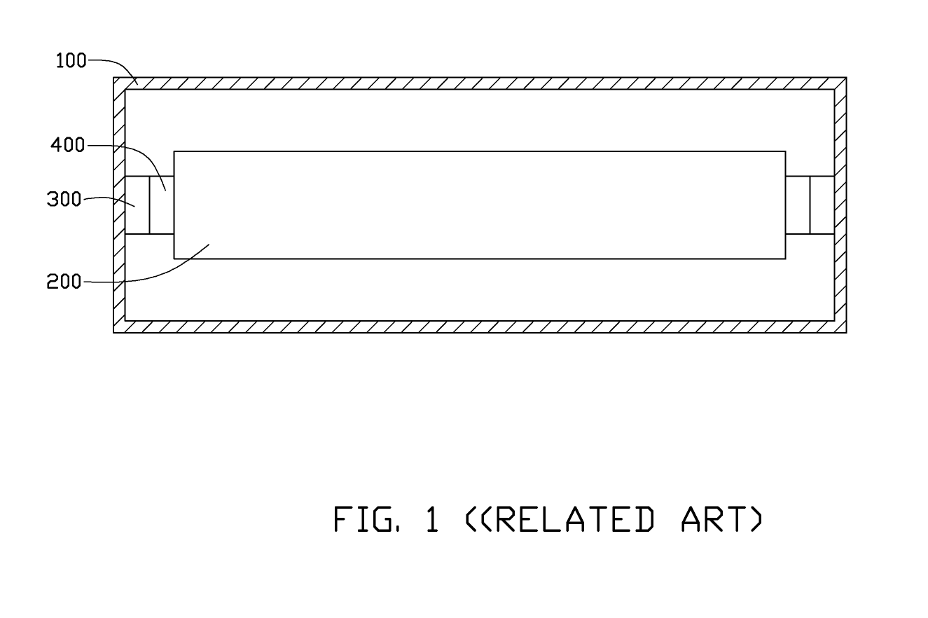

FIG. 2 is a sketch view of an embodiment of a data center.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

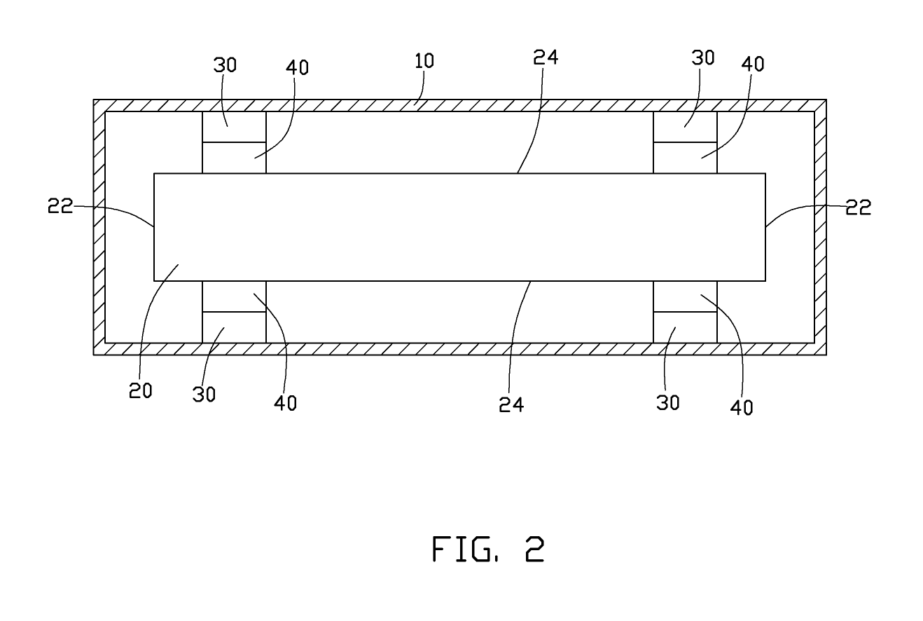

Referring to FIG. 2, an exemplary embodiment of a data center includes a rack 10, at least one server module 20 arranged in the rack 10, two first slide rails 30, and two second slide rails 40.

The server module 20 includes left and right sidewalls 22 substantially parallel to each other, and top and bottom sidewalls 24 substantially parallel to each other. The left and right sidewalls 22 and the top and bottom sidewalls 24 are connected to each other to form a frame. The distance between the left and right sidewalls 22 is larger than the distance between the top and bottom sidewalls 24.

The second slide rails 40 are mounted to the top and bottom sidewalls 24 of the server module 20. The first slide rails 30 are mounted to the rack 10, for mating with the second slide rails 40 to slidably attach the server module 20 to the rack 10.

In this embodiment, the first and second slide rails 30 and 40 of the data center are arranged between the top and bottom sidewalls 24 of the server module 20 and the rack 10, as a result, the left and right sidewalls 22 of the server module 20 may define a number of heat dissipation holes for heat dissipating.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A data center comprising:
a rack;
a server module arranged in the rack, the server module comprising left and right sidewalls, and top and bottom sidewalls, wherein the distance between the left and right sidewalls is larger than the distance between the top and bottom sidewalls;
two first slide rails mounted to the top and bottom sidewalls, respectively; and
two second slide rails mounted to the rack and mating with the first slide rails, to slidably attach the server module to the rack.

2. The data center of claim 1, wherein the left and right sidewalls of the server module define a plurality of heat dissipation holes for heat dissipating.

3. A server module mounted in a rack, the server module comprising:
left and right sidewalls;
top and bottom sidewalls, wherein the distance between the left and right sidewalls is larger than of the distance between the top and bottom sidewalls; and
two slide rails attached to the top and bottom sidewalls, for slidably attaching the server module to the rack.

4. The server module of claim 3, wherein the left and right sidewalls of the server module define a plurality of heat dissipation holes for heat dissipating.
